(19) United States
(12) Patent Application Publication
(10) Pub. No.: US 2010/0322748 A1
(43) Pub. Date: Dec. 23, 2010

(54) AUTOMATIC WAREHOUSE

(76) Inventor: Wan Young Lee, Seoul (KR)

Correspondence Address: SHERIDAN ROSS PC, 1560 BROADWAY, SUITE 1200, DENVER, CO, 80202, US

(21) Appl. No.: 12/526,324

(22) PCT Filed: Aug. 21, 2007
(86) PCT No.: PCT/KR2007/003981

§ 371 Date: Aug. 7, 2009

(30) Foreign Application Priority Data
Feb. 14, 2007 (KR) 10-2007-0015323

(51) Int. Cl. B65G 1/06; B65G 1/04; A47F 5/00

(52) U.S. Cl. 414/281; 211/134; 414/277

(57) ABSTRACT

A rack of the automatic warehouse is comprised with several racks (10) longitudinally arranged in a lattice form to have cargo (W) on each cargo loading area (18), a stacker crane (20) provided between two adjoining racks (10) for moving toward, up or down, or retracting the cargo (W) away from the cargo loading area (18), and a transfer means (30) for moving the cargo (W) from the inside and the outside of the warehouse. The rack is comprised of several pairs of posts (11), pairs of horizontal beams (12), a first brace beam (13), a second brace beam (14), a vertical brace (15), an arm beam (16), and a load arm (17), which are connected to each other to make a matrix pattern. Only two posts are arranged in a narrow width of the rack, allowing access in both longitudinal sides, by which the automatic warehouse has a simple structure, and the structural stability can be secure.

### TECHNICAL FIELD

The present invention relates to an automatic warehouse for effectively storing and controlling a bunch of cargo by an automatic taking-in-or-out method using an automatic facility, and more particularly to the automatic warehouse having a simple structure, by which a lengthy cargo, such as structural steel, steel pipe, thick steel plates for ships, and container, can be safely stored more effectively.

### BACKGROUND ART

The automatic warehouse is a large store means by which a bunch of cargo can be automatically loaded into or unloaded from a cargo stored area by an automatic facility, and a bunch of cargo can be effectively stored and managed with less volume storage space. The automatic warehouse can be utilized at a large volume of cargo flow control system or at a warehouse for various kinds of industrial fields.

Such an automatic warehouse is comprised of a lot of racks arranged at a pre-determined interval, each rack having several cargo loading spaces in a matrix type cell, and such a loading space being able to access from the front and the rear of each rack. The automatic warehouse is further comprised of a cargo loading/unloading apparatus, such as a lift or stacker crane, which runs in a hallway configured between the adjacent two racks, and takes out or retrieves the cargo from/into a cargo lading space. Furthermore, the automatic warehouse is comprised of subsidiary facilities, such as a conveyor or AGV that runs between a warehouse and the outside of the warehouse. All of components are controlled by central computer system.

In the automatic warehouse structure, a rack structure is very important to attain a stable support for the cargo since the rack should support heavy weight cargo being stacked in multiple layers. Specially, the rack should have a bidirectional loading/unloading accessibility at the respective front and rear longitudinal walls so that cargo can be easily loaded/unloaded and thus the effective space utility can be gained.

Therefore, the rack is configured as several stories of steel structure built in a matrix manner with structural steels, such as I-beam etc. Since a cargo should access the rack in opposite directions respectively from the front and rear gate, a brace must be installed at the middle of the longitudinal width of the rack so as to allow the rack to be free from distortion or buckling and not interfering with the access of cargo.

In a conventional storage rack, to obtain structural stability, the storage rack is structured as “3-Post type post rack” that arranges three posts along a longitudinal width of the rack or “4-Post type post rack” that arranges four posts along a longitudinal width of the rack. Furthermore, a brace is linked with one or two posts that are located at the middle of the horizontal width of the rack.

However, it increases the quantities of fabricated material needed since one or two posts are additionally installed at the middle of the horizontal width of the rack so as to install the brace. Also, it increases the connection points. Therefore, the material cost and the production cost would be increased, and it lengthens the construction period. This reduces productivity and workability while building an automatic warehouse having such a storage rack.

The inside posts form dead space in the storage racks, thus finally reducing the utility of space in the automatic warehouse.

The applicant suggests the two post type storage rack for automatic warehouse under Korean Patent Publication 10-0344326 (U.S. Pat. No. 6,216,893) to solve the above problem.

In this technology, a brace beam is installed between a pair of posts that are distanced along the width of the rack. A bracket is installed at the center of the respective brace beams. Each end of the vertical brace extended diagonally, is connected with each end of the adjacent brackets. Thus, the storage rack has simple structure, and can get high structural stability.

However, the conventional patent has adopted that the brace beam is installed between only a pair of the posts. Thus, it is suited for the storage of small volume cargo. It is hard to get structural stability for long length cargo, such as steel materials (I-beam), steel pipe, steel plate, thick steel plates for ships, or containers for marine transportation.

That is, in the view of the structure of the storage rack and the efficiency of the loading/unloading, the long length cargo must be handled at the middle area of the longitudinal direction. This leaves a wide gap between the adjacent posts in the longitudinal direction since the gap of the post must be larger than the length of the cargo. The distance between the supporting points that firmly hold each end of the brace beam should be widened, and it makes the size of the brace big, and also the chance of buckling increases. That does great harm to a structural stability for an automatic warehouse.

### DISCLOSURE OF INVENTION

### Technical Problem

Accordingly, the present invention has been made with taking the above problems occurring in the prior art into consideration, and the object of the present invention is to provide an automatic warehouse having a simple structure by adopting only two posts installed in the horizontal direction, by which the structural stability can be attained. Furthermore, lengthy cargo such as structural steel, steel pipe, thick steel plates for ships, and containers, can be safely stored in a more effect since the distance between points of the vertical brace installed at the middle of the rack could shortened.

### Technical Solution

In order to accomplish the above object, an automatic warehouse comprised of several racks longitudinally arranged in a lattice form to have cargo on each cargo loading area, a stacker crane provided between two adjoining racks for moving toward, up or down or retreating the cargo away from a cargo loading area, and a transfer means for moving the cargo from the inside and the outside of the warehouse, the rack of the automatic warehouse is comprised: each pair of posts that is comprised of two posts which are arranged vertically along width at a predetermined interval to each other, and multiple lattice which are connected to the two posts in a zig-zag manner, and is arranged at a predetermined interval to each other in a lengthwise direction of the rack; a horizontal beam that is comprised of two horizontal beams which are arranged between a pair of posts, each horizontal beam being connected to the adjacent posts, respectively, and multiple horizontal braces which are connected with two horizontal beams in a zig-zag manner; a first brace beam that is horizontally installed between two posts in a perpendicular manner with respect to each post, and having a brace beam that is provided at the middle of the longitudinal direction of the first brace beam; a second brace beam that is horizontally installed between two horizontal beams in a perpendicular manner to each horizontal beam, and having a brace beam that is provided at the middle of the longitudinal direction of the second brace beam; two vertical braces that are diagonally extended from the first and second brace beam with being crossed with each other; an arm beam that is extended horizontally to the cargo load area of the rack from respective posts; and a load arm that is attached to the free end of the arm beam extended from each front/rear post in a perpendicular manner, and is extended horizontally toward the front and the rear of the rack, and supports the cargo.

In accordance with a preferred feature of this invention, the two transit forks of the stacker crane are provided at a predetermined distance from each other along the longitudinal direction of the cargo.

In accordance with a preferred feature of this invention, a pad is further mounted on the load arm to support a round cargo, the center of the upper surface of the pad is low, each ends of the pad is tapered outward, and the round cargo, such as a steel coil, can be stable when placed on the load arm.

### Advantageous Effects

According to the present invention, just only two posts are arranged in a narrow width of the rack, allowing access in both longitudinal sides, by which the automatic warehouse has a simple structure, and the structural stability can be secure. Specially, in the rack having the long distance between the posts poisoned at each longitudinal end, the end point distance of the vertical brace installed at the middle of the narrow width of the rack can be shortened. Thus, very long and heavy weight cargo, e.g. structure steel (I-beam), containers for marine transportation can stored in a very stable manner.

Therefore, the present invention has an advantage, the structure stability, the operational reliability, and the constructional efficiency can be accomplished. The usage for volume and its economical issue can be a considerable advantage.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view of an automatic warehouse according to a present invention;

FIG. 2 is a plan view schematically showing an automatic warehouse;

FIG. 3 is a front view schematically showing an automatic warehouse;

FIG. 4 is a cross-sectional view taken along line IV-IV of FIG. 3;

FIG. 5 is a perspective view of a rack of the automatic warehouse according to a present invention;

FIG. 6 is a plan view of the rack shown in FIG. 5;

FIG. 7 is a front view of the rack taken along line VII-VII of FIG. 6;

FIG. 8 is a cross-sectional view of a middle rack taken along line VIII-VIII of FIG. 6;

FIG. 9 is a side view of an edge rack taken along line IX-IX of FIG. 6;

FIG. 10 is a perspective view showing vertical brace connections of the rack of the automatic warehouse according to the present invention;

FIG. 11 is a plan view of a stacker crane of the automatic warehouse;

FIG. 12 is a cross-sectional view taken along line XII-XII of FIGS. 11; and

FIGS. 13 and 14 are a plan and a side view showing another embodiment of a rack of an automatic warehouse, respectively.

### BEST MODE FOR CARRYING OUT THE INVENTION

This invention will be described in further detail by way of exemplary embodiments with reference to the accompanying drawings.

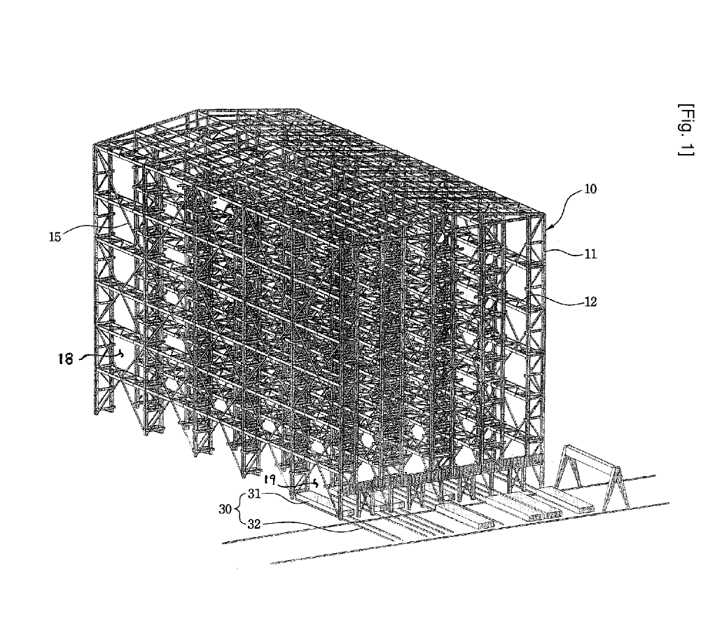

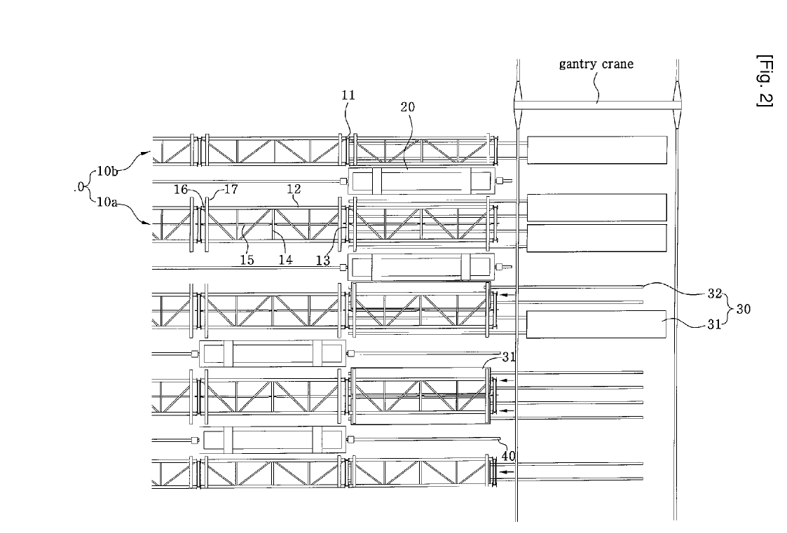

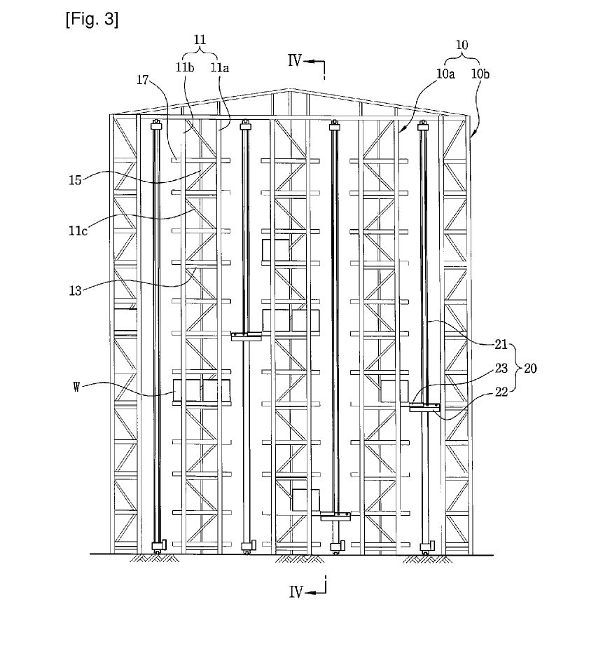

Referring to FIGS. 1 to 4, an automatic warehouse according to a present invention is comprised with several racks 10 longitudinally arranged in a lattice form to have cargo “W” on each cargo loading area 18, a stacker crane 20 provided between two adjoining racks 10 for moving toward, up or down, or retracting the cargo “W” away from the cargo loading area 18, and a transfer means 30 for moving the cargo “W” from the inside and the outside of the warehouse.

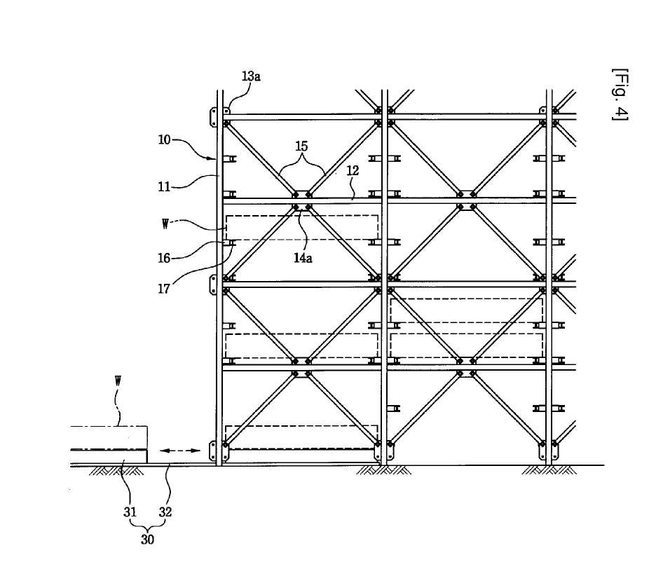

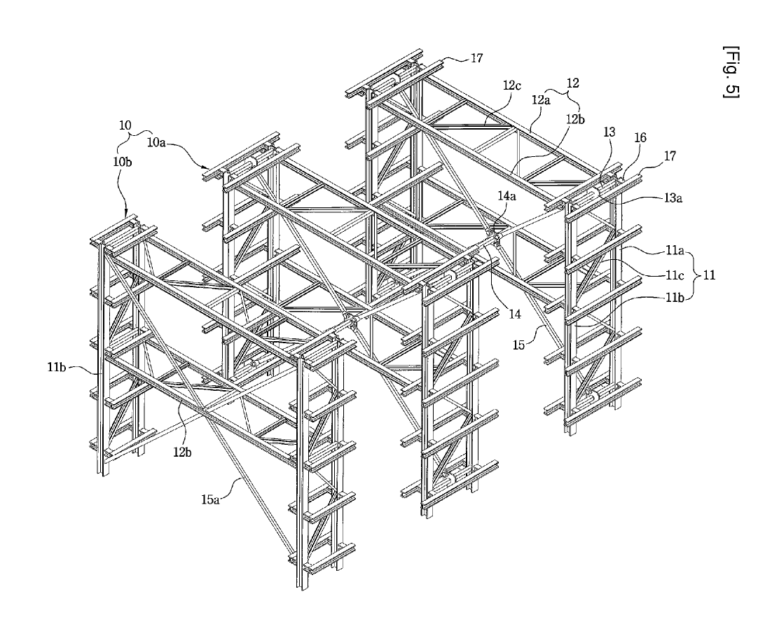

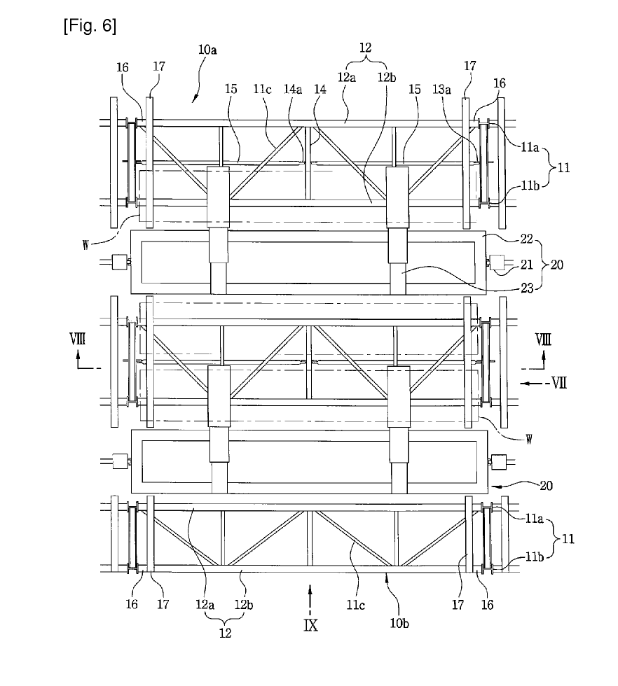

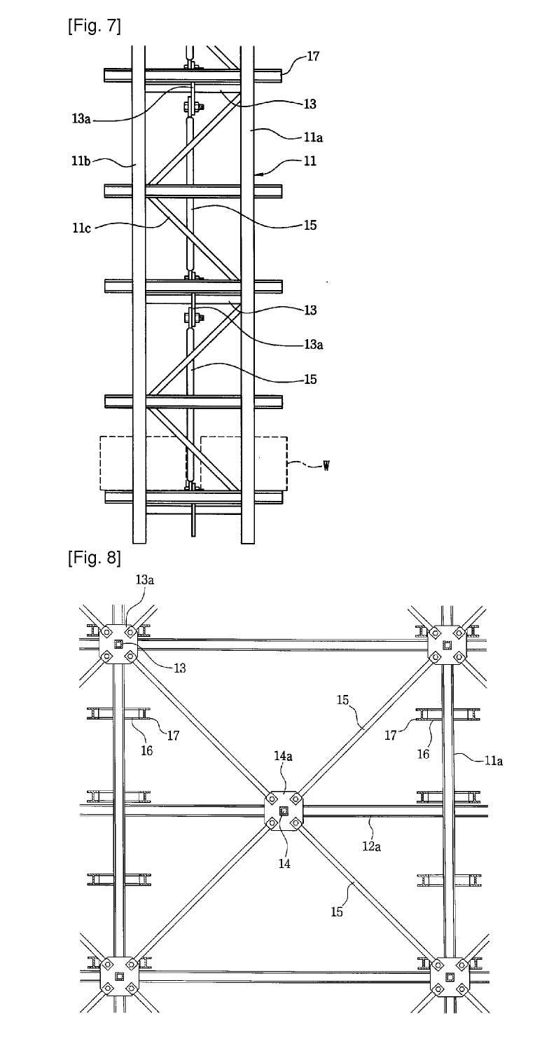

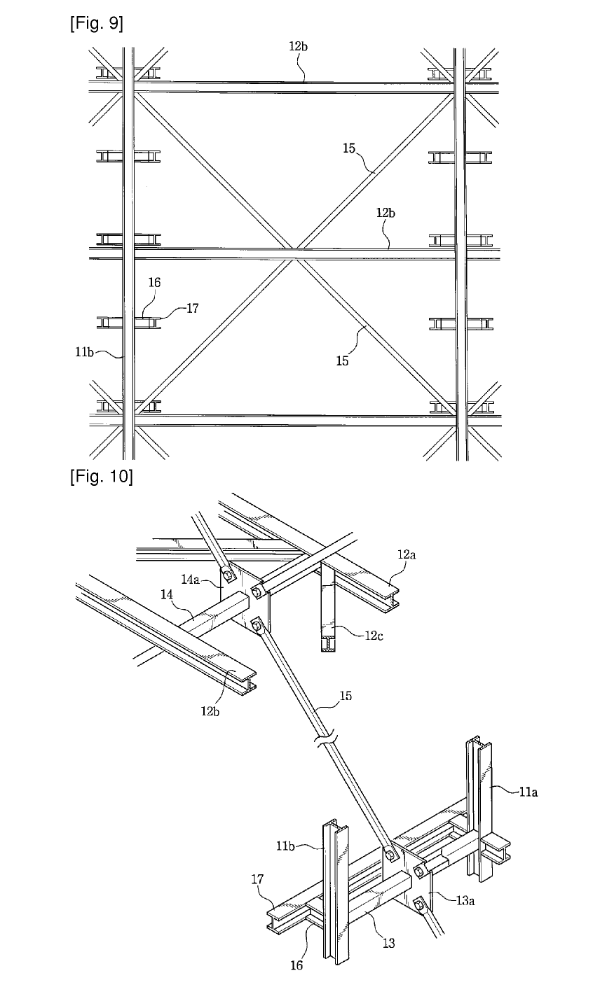

The rack 10, as shown in FIGS. 5 to 10, is comprised of several pairs of posts 11, pairs of horizontal beams 12, a first brace beam 13, a second brace beam 14, a vertical brace 15, an arm beam 16, and a load arm 17, which are connected to each other to make a matrix pattern.

Each pair of posts 11 is comprised of two posts 11a, 11b which are arranged vertically along width at a predetermined interval to each other, and multiple lattice 11c which are connected to the two posts 11a, 11b in a zig-zag manner. The pair of posts 11 is arranged at a predetermined interval to each other in a lengthwise direction of the rack 10.

The distance between each pair of posts 11 is larger than the length of the cargo “W” (e.g. I-beam) that has a long length.

The posts 11a, 11b support primarily the vertical load of the cargo “W” each of which is made with an I-beam having a high tensile strength. It is preferable that an axle of each post 11a, 11b is arranged to the arm beam 16 in the parallel direction since the post must endure a bending moment transferred from the arm beam 16.

Furthermore, the vertical lattice 11c linked to the each post 11a, 11b in a slant manner can prevent the bucking of the post 11a, 11b, and resists the lateral force of the post 11a, 11b.

The horizontal beam 12 is comprised of two horizontal beams 12a, 12b which are arranged between a pair of posts 11, each horizontal beam 12a, 12b being connected to the adjacent posts 11a, 11b, respectively, and multiple horizontal braces 12c which are connected with two horizontal beams 12a, 12b in a zig-zag manner.

The horizontal beam 12 can support a horizontal force of the post 11 and prevents the bucking of the posts 11a, 11b from occurring. The horizontal beam 12 is stacked at a predetermined interval so as to complete the cargo loading area 18 along with the pair of posts 11. The plural horizontal braces 12c are connected integrally with the horizontal beams 12a, 12b, and ensure the horizontal stiffness of the rack to be free from the distortion of the rack 10.

The horizontal beam 12 must take on a burden of bending moment exerted from the vertical load that comes from the support of a second brace beam 14 (explained later). It is preferable that the horizontal beam 12 is made with an I-beam having a large bending resistance force, and its web's axis should be installed in a vertical way.

The first brace beam 13 is horizontally installed between two posts 11a, 11b in a perpendicular manner with respect to each post 11a, 11b. In the view of multiple stack rack 10, each first brace beam 13 is located at each diagonal extension corner of each rack 10.

A brace beam 13a shaped with a plate is provided at the middle of the longitudinal direction of the first brace beam 13, and the vertical beam 15 is connected with one diagonal corner of the brace beam 13a. The brace beam 13 can be welded on the surface of the brace beam 13a. More preferably, the brace beam 13a can be installed through the first brace beam 13 so that the force transferred from multiple vertical braces 15 can be completely received.

The second brace beam 14 is horizontally installed between two horizontal beams 12a, 12b in a perpendicular manner to each horizontal beam 12a, 12b. Thus, the second brace beam 14 can give reinforcement between the longitudinal adjoining posts 11 of the rack 10, in which the distance between the posts 11 should be longer than the length of the cargo “W”.

The second brace beam 14 does not connect to all the horizontal beams 12, but connected to the horizontal beam 12 that is positioned at a predetermined height, at which two vertical braces 15 that are diagonally extended from the brace beam 13, can be crossed with each other.

The second brace beam 14 has a brace beam bracket 14a at the middle of the second brace beam 14, which can connect the arm beam 15. The brace beam bracket 14a can be installed through the second brace beam 14 so that the force transferred from the multiple vertical braces 15 can be completely received, which is the same case of the first beam bracket 13a. The second brace beam 14 is split into two, and is mounted axially on both surfaces of the brace beam bracket 14a.

Herein, the first and second brace beam 13, 14 can firmly hold the vertical brace 15, and can transfer the stress of the arm brace 15 to each post 11a, 11b. Since the brace beam 13, 14 must receive a vertical and horizontal stress from the vertical brace 15, it is preferable that the brace beam 13 should be made with a structural material that is strong torsion strength, and has the same bending force in any direction.

Therefore, as shown in FIG. 8, steel pipe having rectangular or round profile can be employed, which is strong in vertical and horizontal stress, and has an iso-directional stiffness. Thus, torsion and bending force acting on the arm brace 15 can surely be transferred to the post 11a, 11b.

The vertical brace 15 is a structure for supporting the horizontal force in the brace surface. As shown in FIG. 10, one end of the vertical brace 15 is connected to the brace beam bracket 13a of the first brace beam 13 installed between the posts 11. The other end of the vertical brace 15 is connected to the brace beam bracket 14a of the second brace beam 14 installed between the horizontal beams 12. In perspective view, the vertical brace 15 is extended diagonally through the center of the width of the rack 10.

With the consideration of the structure allowing the cargo “W” to load or unload through the front and rear longitudinal gate of the rack 10, the vertical brace 15 is located at the border between the front and rear cargo loading area 18, by which the forking operation of the stacker crane 20 is free from interfering with either the front or rear access. It is preferable that the vertical brace 15 should be made from steel pipe strong enough to prevent bulking, because of the axial force transfer.

Each arm beam 16 is extended horizontally to the cargo load area 18 of the rack 10 from respective posts 11a, 11b, and support the load arm 17 that will be explained later.

In the case that the load arm 17 is directly mounted on the horizontal beam 12, the load strength of the horizontal beams 12a, 12b should be increased. Thus, to consider the economic view, the arm beam 16 is separately employed to support the load arm 17. Furthermore, the arm beam 16 provides enough room between a pair of horizontal beams 12 and the load arm 17. The transit fork 23 of the stacker crane 20 can marginally access into the cargo loading area 18 free from interfering with the horizontal beam 12.

The load arm 17 directly supports the cargo “W” placed on the load arm 17. The load arm 17 is attached to the free end of the arm beam 16 extended from each front/rear post 11a, 11b in a perpendicular manner, and is extended horizontally toward the front and the rear of the rack 10. That is, each free end of the load arm 17 is extended beyond a pair of horizontal beams 12a, 12b at a predetermined overhang. Thus, the extended load arm 17 secures a larger area on the cargo load space 18, which give more volume to the rack 10 being able to access the front and the rear thereof.

Herein, as shown in FIG. 5, being different from the middle rack 10a, the edge rack 10b has a different structure, in which the load/unloading of the cargo “W” can be achieved at only one side of each edge rack 10b. The narrow width of the edge rack 10b is relatively smaller than that of the middle rack 10a. Furthermore, the vertical brace 15 that supports the horizontal force of the rack 10 is not installed at the middle of the narrow width of the rack 10, but is installed directly on the post 11b and the horizontal beam 12b that are located on the side opposite to the access to the cargo loading area 18.

On the other hand, in the present invention, one cargo loading area 18 that is located in each rack 10 can function as a cargo standby area 19, in which the stacker crane 20 can load/unload the cargo “W” and the cargo standby area 19 is open to the outside of the rack 10. To achieve above purpose, the transfer means 30 can be extended into the cargo standby area 19 of each rack 10.

The transfer means 30 can be made from various devices, for instance, as shown in FIGS. 1, 2 and 4, the rail 32 is installed between the outside and the inside of the cargo standby area 19 of the rack 10. A carriage 31 that moves on the rail 32 can be employed.

Furthermore, there is no additional drawing, but a conveyor can be installed between the inside and the outside of the warehouse. The two racks 10 are facing to each other, and one of the cargo standby area 19 of the rack 10 can be used as the cargo loading area, while the other of the cargo standby area 19 of the rack 10 can be used as the cargo unloading area.

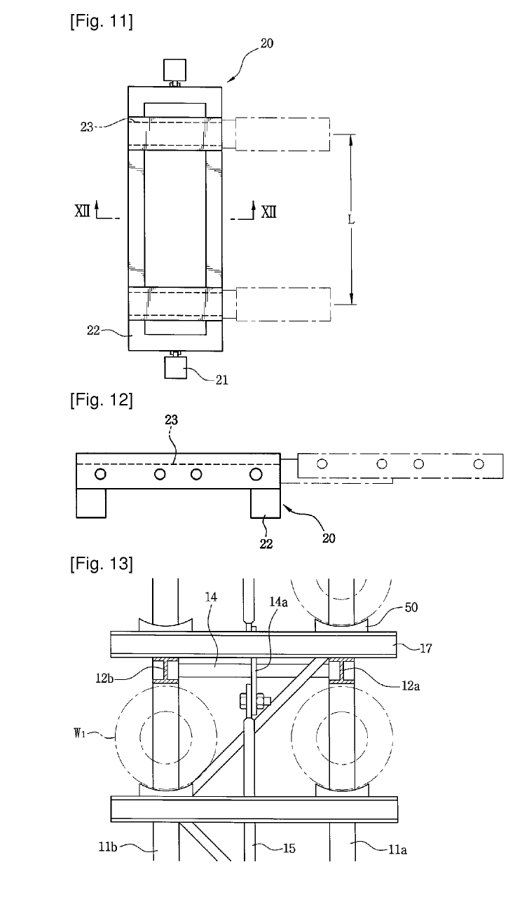

The stacker crane 20, as well known, is positioned in the hallway between the adjacent racks 10, and moves forward and backward along a rail 40 located on the floor and the ceiling of the hall way in a longitudinal direction of the rack 10. The carriage 22 has a structure that moves up and down along the mast 21. As shown FIGS. 11 and 12, the carriage 22 has the transit fork 23 that operates horizontally by a driving means (not shown), and loads the cargo “W” on the load arm 17 or unloads the cargo “W” from the load arm 17.

The transit fork 23 can take a two step sliding structure for a quick load/unloading operation of the cargo “W”. In this embodiment, it is preferable that two transit forks 23 of the stacker crane 20 are provided at a predetermined distance from each other along the longitudinal direction of the cargo “W”. It is for the stable transfer or load/unload of cargo that is long in length such as structural steels (I-beam) or container for marine transportation.

The distance “L” between the transit forks 23 is preferably larger than half length of the cargo “W”. It can secure enough room of support volume at the center portion of the cargo “W” when the carriage or fork lift loads or unloads the cargo “W” on/from the stacker crane 20.

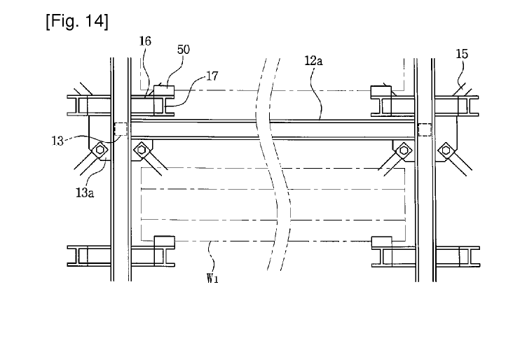

Furthermore, as shown FIGS. 13 and 14, a support pad 50 is provided on the cargo load point of the load arm 17. Thus, the round cargo “W ₁” such as a water pipe, sewer pipe, steel pile, or a steel coil, can be stable when placed on the load arm 17.

If the round cargo “W₁” is stored on the flat load arm 17, there is concern it may roll out-of-place. It is necessary to support the round cargo at the predetermined points. Thus, an additional pad 50 for the round cargo can be employed, and it is attached on the load arm, if necessary.

Such a pad 50 can have various shapes, for instance, the center of upper surface is low, and each ends thereof is tapered outward. The upper surface can be formed as a concave having a predetermined curvature or in a V-shape.

To provide the maximum slip resistance, its material can be made from a high abrasive sufficient and good adherence (i.e. rubber or urethane).

In the inventive automatic warehouse having the above structure, the rack 10 that is able to load/unload in both access ways has the cargo loading area 18 at the front and the rear longitudinal side, respectively. Only two posts 11a, 11b—minimum quantity—are provided at the width of the rack 10, which is a simple structure. Furthermore, the vertical brace 15 is located at the middle of the width of the rack 10, and the respective vertical brace 15 is firmly connected to the posts 11a, 11b and the horizontal beam 12a, 12b through the first and the second brace beam 13, 14. Thus, a structural stability can be secured.

Specially, the longitudinal length between the adjoining posts 11 should be long to store lengthy cargo “W” such as structural steel (I-beam), or containers for marine transportation. However, the second brace beam 14 is installed at the middle of the longitudinal width of the horizontal beam 12 that holds the post 11. The first brace beam 13 and the second brace beam 14 are connected with the arm brace 15. Thus, the length of the arm brace 15 can be shortened. It withstands buckling.

That is, in a conventional rack, a vertical brace connects the adjoining posts, while in the inventive rack, the distance between the pair of posts 11 becomes wide, but the second brace beam 14 is located at the middle of the horizontal beam 12 that connects the pair of posts 11. And, the single vertical brace 15 does not connect directly to the first brace beam 13 mounted on the post 11, but two vertical braces 15 can connect to each post 11 via the second brace beam positioned at the middle of the second brace beam 14. The distance between the points of the vertical brace 15 can be drastically shortened, and thus the size of the vertical brace 15 becomes small, and more the resistance force against buckling can be increased.

Furthermore, in line with above structure, the transit fork 23 of the stacker crane 20 loads/unloads the cargo “W” against the rack 10. Two transit forks 23 are distanced to each other in a longitudinal direction. Thus, the cargo “W” can securely be transferred. More, other transit means e.g. forklift can freely support the cargo “W” at the middle and each end of the horizontal beam 12 except the place occupied by the transit fork 23. The transfer, load/unload, and storage of the cargo “W” can be achieved very convenient in spite of the lengthy cargo.

### INDUSTRIAL APPLICABILITY

As described above, according to the present invention, just only two posts are arranged in a narrow width of the rack, allowing access in both longitudinal sides, by which the automatic warehouse has a simple structure, and the structural stability can be secure. Specially, in the rack having the long distance between the posts poisoned at each longitudinal end, the end point distance of the vertical brace installed at the middle of the narrow width of the rack can be shortened. Thus, very long and heavy weight cargo, e.g. structure steel (I-beam), containers for marine transportation can stored in a very stable manner.

Furthermore, two transit forks of the stacker crane for loading/unloading the cargo are distanced from each other above the carrier in a longitudinal direction, and the stable transfer and load/unload process for the lengthy cargo can be achieved.

Therefore, the present invention has an advantage, the structure stability, the operational reliability, and the constructional efficiency can be accomplished. The usage for volume and its economical issue can be a considerable advantage.

1. An automatic warehouse comprised of several racks longitudinally arranged in a lattice form to have cargo on each cargo loading area, a stacker crane provided between two adjoining racks for moving toward, up or down or retreating the cargo away from a cargo loading area, and a transfer means for moving the cargo from the inside and the outside of the warehouse, the rack of the automatic warehouse comprising:
each pair of posts that is comprised of two posts which are arranged vertically along width at a predetermined interval to each other, and multiple lattice which are connected to the two posts in a zig-zag manner, and is arranged at a predetermined interval to each other in a lengthwise direction of the rack;
a horizontal beam that is comprised of two horizontal beams which are arranged between a pair of posts, each horizontal beam being connected to the adjacent posts, respectively, and multiple horizontal braces which are connected with two horizontal beams in a zig-zag manner;
a first brace beam that is horizontally installed between two posts in a perpendicular manner with respect to each post, and having a brace beam that is provided at the middle of the longitudinal direction of the first brace beam;
a second brace beam that is horizontally installed between two horizontal beams in a perpendicular manner to each horizontal beam, and having a brace beam that is provided at the middle of the longitudinal direction of the second brace beam;
two vertical braces that are diagonally extended from the first and second brace beam with being crossed with each other;
an arm beam that is extended horizontally to the cargo load area of the rack from respective posts; and
a load arm that is attached to the free end of the arm beam extended from each front/rear post in a perpendicular manner, and is extended horizontally toward the front and the rear of the rack, and supports the cargo.

2. The automatic warehouse according to claim 1, wherein: the first brace beam, the second brace beam and the vertical brace are made from steel pipe.

3. The automatic warehouse according to claim 1, wherein: each brace beam is installed through the brace beam bracket.

4. The automatic warehouse according to claim 1, wherein: the post is made from an I-beam, a web's axis of the I-beam is parallel to an extension direction of the arm beam.

5. The automatic warehouse according to claim 1, wherein: the horizontal beam is made from an I-beam, and its web's axis is installed in a vertical way.

6. The automatic warehouse according to claim 1, wherein: a cargo loading area located at a edge rack functions as a cargo standby area, in which the transfer means moves in/out the cargo standby area to load/unload the cargo, and the cargo standby area is open to the outside of the rack.

7. The automatic warehouse according to claim 6, wherein: a rail is installed at the cargo standby area of the rack, the rail is extended toward the outside of the rack, and the transfer means is a carriage that moves on the rail.

8. The automatic warehouse according to claim 6, wherein: the transfer means is a conveyor that is extended toward the outside of the cargo standby area.

9. The automatic warehouse according to claim 1, wherein: the two transit forks of the stacker crane are provided at a predetermined distance from each other along the longitudinal direction of the cargo.

10. The automatic warehouse according to claim 9, wherein: the distance between the transit forks is larger than half length of the cargo.

11. The automatic warehouse according to claim 1, wherein: a pad is further mounted on the load arm to support a round cargo, the center of the upper surface of the pad is low, each ends of the pad is tapered outward.

12. The automatic warehouse according to claim 11, wherein: the pad is made from a high abrasive sufficient and good adherence such as rubber or urethane.
